(19) United States
(12) Patent Application Publication
(10) Pub. No.: US 2026/0340474 A1
(43) Pub. Date: Oct. 29, 2026

(54) QUANTUM COMPUTING DEVICE FOR INVERSE NOISE CHARACTERIZATION AND ERROR MITIGATION BY RESTRICTED EVOLUTION AND METHOD THEREOF

(71) Applicant: LG ELECTRONICS INC., Seoul (KR)

(72) Inventors: Gaurav Saxena, Toronto (CA); Thi Ha Kyaw, Burlington (CA); Jack Baker, Pickering (CA); Pablo Diez Valle, Madrid (SP)

(73) Assignee: LG ELECTRONICS INC., Seoul (KR)

(21) Appl. No.: 19/658,207

(22) Filed: Apr. 24, 2026

Related U.S. Application Data
(60) Provisional application No. 63/794,979, filed on Apr. 25, 2025.

(51) Int. Cl. G06N 10/70; G06N 10/20; G06N 10/60

(52) U.S. Cl. CPC G06N 10/70; G06N 10/20; G06N 10/60

(57) ABSTRACT

An error mitigation method for a quantum computing device can include receiving a quantum circuit configuration and obtaining a set of hardware-implementable quantum gates. The method can determine an inverse noise representation based on a noise representation of a physical implementation of a target gate. A generalized quasi-probabilistic decomposition of the inverse noise representation can be generated, including a positive component and a negative component. An updated quantum circuit configuration can be generated by inserting at least one implementable quantum gate subsequent to the target gate. The inserted gate is selected to correspond to the positive component of the decomposition, while the negative component can be explicitly excluded. The updated quantum circuit configuration is transmitted to the quantum computing device for physical execution, and an error-mitigated expectation value is received based on the execution.

### CROSS-REFERENCE TO RELATED APPLICATIONS

This non-provisional application claims priority under 35 U.S.C. § 119 (e) to U.S. Provisional Application No. 63/794,979, filed on Apr. 25, 2025, the entirety of which is hereby expressly incorporated by reference into the present application. This application also incorporates by reference the entire disclosure of U.S. Pat. No. 12,572,839, filed on Jul. 31, 2024.

### BACKGROUND

### Field

The present disclosure relates to a quantum computing device and method for experimental noise characterization and error mitigation. Particularly, the method can perform inverse noise characterization to execute error mitigation by restricted evolution (EMRE) in the fields of quantum computing and artificial intelligence (AI).

### Discussion of the Related Art

Quantum computers represent a revolutionary leap forward in computing technology with their potential to solve complex problems exponentially faster than classical computers.

Unlike classical computers that use transistors to implement binary bits, which can be either 0 or 1, quantum computers use qubits. Qubits can exist in a superposition of states, allowing them to perform multiple calculations simultaneously and potentially tackle problems that are intractable by classical computers.

For example, quantum computers promise a quantum advantage in numerous applications, such as factoring, solving linear systems, quantum simulations, and quantum chemistry/material discovery.

However, the power of quantum computers comes with unique challenges, such as dealing with noise and decoherence. Quantum systems are inherently fragile and susceptible to various sources of noise and errors. These errors can arise from interactions with the environment, imperfections in physical hardware components, or limitations in control and measurement mechanisms.

For example, hybrid quantum computers that implement an architecture of a classical computer and a quantum computer working together to solve a problem, also referred to as noisy intermediate scale quantum (NISQ) computers, can execute algorithms that are often designed for short-depth quantum circuits having limited numbers of qubits and gates, e.g., variational quantum algorithms (VQAs) and in the form of a hybrid quantum-classical feedback loop.

However, even NISQ computers having short-depth quantum circuits are not fault tolerant, and the presence of noise and errors can limit their utility. For example, the result or expectation value output by a quantum computer may be so influenced by noise and errors that its output becomes unreliable or unusable.

In order to extend the reach of near-term quantum computers and NISQ computers, error mitigation techniques are used, such as deploying a mixture of quantum sampling and classical post-processing techniques.

However, many existing error mitigation techniques require either exponential copies of quantum states or an exponential number of sampling measurements, with respect to the amount of noise present in the quantum hardware. Thus, such techniques become impractical with an increase in the system size and have exponential runtime (e.g., O(2\hat{ }n)).

For example, zero-noise extrapolation (ZNE) and theoretical probabilistic error cancelation (PEC) are two types of algorithms that can be used for dealing with errors in quantum computers. While theoretical PEC can give an unbiased estimate of the expectation value, it does so at the cost of an exponential sampling overhead (e.g., exponential runtime). On the other hand, ZNE gives a biased estimate by applying the quantum circuit several times and extrapolating the results of each run, in order to get a result which is often inaccurate and is computationally expensive.

In practical, physical quantum computing environments, hardware noise is highly complex and generally unknown prior to execution. Many existing error mitigation approaches rely on the assumption that a fully pre-characterized and accurate noise model is already available. Consequently, these techniques are often difficult to deploy on actual physical hardware, where the true operational noise profile remains uncharacterized or acts as an unpredictable black box.

Thus, there exists a need for a quantum computing device and method capable of experimentally characterizing unknown physical hardware noise in order to practically apply compute saving error mitigation protocols.

Further, a need exists for a direct experimental technique capable of extracting an inverse noise representation from a target gate and executing restricted evolution based on that measured representation, in order to provide a reliable error-mitigated expectation value without exponential sampling overhead.

### SUMMARY OF THE DISCLOSURE

The present disclosure has been made in view of the above problems, and it is an object of the present disclosure to provide a quantum computing device and method capable of characterizing unknown hardware noise to mitigate computational errors. Further, the present disclosure provides a hardware based method for extracting an inverse noise representation to execute error mitigation by restricted evolution (EMRE) in the fields of quantum computing and artificial intelligence (AI).

An object of the present disclosure is to provide a method for mitigating error in a quantum computing device that includes characterizing a target quantum gate of a quantum circuit configuration to determine a measured noise representation, calculating an inverse noise representation based on the measured noise representation, generating a quasi-probabilistic decomposition corresponding to the inverse noise representation, the quasi-probabilistic decomposition including a positive component and a negative component, generating an updated quantum circuit configuration by inserting at least one implementable quantum gate subsequent to the target gate corresponding to the positive component of the quasi-probabilistic decomposition while excluding the negative component, and executing the updated quantum circuit configuration, by the quantum computing device, to generate an expectation value.

Another object of the present disclosure is to provide a method for mitigating error in a quantum computing device that can include receiving quantum circuit specification data defining a quantum circuit configuration, the quantum circuit configuration specifying a plurality of quantum gates, obtaining a set of implementable quantum gates, each of the implementable quantum gates corresponding to a quantum operation capable of being executed by hardware of the quantum computing device, determining a noise representation associated with a physical implementation of a target gate among the plurality of quantum gates, determining an inverse noise representation based on the noise representation, generating a generalized quasi-probabilistic decomposition of the inverse noise representation based on the set of implementable quantum gates, the generalized quasi-probabilistic decomposition including a positive component and a negative component, generating an updated quantum circuit configuration by inserting at least one implementable quantum gate subsequent to the target gate, in which the at least one implementable quantum gate is selected from among the set of implementable quantum gates to correspond to the positive component of the generalized quasi-probabilistic decomposition, and the negative component of the generalized quasi-probabilistic decomposition is excluded, transmitting the updated quantum circuit configuration to the quantum computing device for execution, and receiving an expectation value from the quantum computing device based on the execution of the updated quantum circuit configuration.

It is another object of the present disclosure to provide a method, in which the determining the noise representation includes generating a measured transfer matrix of the target gate, and extracting a noise matrix as the noise representation by multiplying the measured transfer matrix by an inverse of an ideal transfer matrix corresponding to the target gate.

Yet another object of the present disclosure is to provide a method, in which the generating the measured transfer matrix includes causing an execution of an on-hardware gate set tomography (GST) protocol on the quantum computing device.

An object of the present disclosure is to provide a method that further includes receiving a plurality of measurement outcomes from the quantum computing device based on a plurality of iterations of the updated quantum circuit configuration being run on the quantum computing device, and computing the expectation value as an average of the plurality of measurement outcomes without tracking a parity sign to reduce a statistical sampling overhead.

Another object of the present disclosure is to provide a method, in which the target gate is a multi-qubit gate, and the method further includes selectively skipping an error mitigation process for at least one single-qubit gate among the plurality of quantum gates to reduce a computational overhead.

An object of the present disclosure is to provide a method, in which the generating the generalized quasi-probabilistic decomposition includes discarding all negative coefficients from a linear combination of physically implementable basis gates associated with the inverse noise representation, and re-normalizing remaining positive weights to create a strictly-positive probability distribution for a location of the target gate.

Yet another object of the present disclosure is to provide a method, in which the generating the updated quantum circuit configuration includes stochastically sampling the at least one implementable quantum gate from the strictly-positive probability distribution using a Monte Carlo sampling technique.

An object of the present disclosure is to provide a method, in which the at least one implementable quantum gate inserted subsequent to the target gate includes a Pauli gate.

Another object of the present disclosure is to provide a method, in which the generating the updated quantum circuit configuration includes generating a plurality of unique circuit configurations for a plurality of hardware shots, and a randomized selection process dynamically inserts a varying sampled implementable quantum gate subsequent to the target gate for individual hardware shots among the plurality of hardware shots.

An object of the present disclosure is to provide a method that further includes inputting the expectation value into a classical optimizer as a cost function or a gradient metric, and iteratively updating a parameter of the quantum circuit configuration based on the expectation value to minimize the cost function and output an optimized solution for a downstream computational task.

Another object of the present disclosure is to provide a method, in which the classical optimizer executes a hybrid quantum-classical algorithm including at least one of a variational quantum eigensolver (VQE) algorithm, a quantum approximate optimization algorithm (QAOA), or a quantum machine learning (QML) training loop.

Another object of the present disclosure is to provide an artificial intelligence (AI) device including a memory configured to store measured expectation values, and a controller configured to receive quantum circuit specification data defining a quantum circuit configuration, the quantum circuit configuration specifying a plurality of quantum gates, obtain a set of implementable quantum gates, each of the implementable quantum gates corresponding to a quantum operation capable of being executed by hardware of a quantum computing device, determine a noise representation associated with a physical implementation of a target gate among the plurality of quantum gates, determine an inverse noise representation based on the noise representation, generate a generalized quasi-probabilistic decomposition of the inverse noise representation based on the set of implementable quantum gates, the generalized quasi-probabilistic decomposition including a positive component and a negative component, generate an updated quantum circuit configuration by inserting at least one implementable quantum gate subsequent to the target gate, wherein the at least one implementable quantum gate is selected from among the set of implementable quantum gates to correspond to the positive component of the generalized quasi-probabilistic decomposition, and wherein the negative component of the generalized quasi-probabilistic decomposition is excluded, transmit the updated quantum circuit configuration to the quantum computing device for execution, and receive an expectation value from the quantum computing device based on the execution of the updated quantum circuit configuration.

An object of the present disclosure is to provide a non-transitory computer readable medium storing computer-executable instructions that when executed by one or more processors, cause the one or more processors to perform operations of receiving quantum circuit specification data defining a quantum circuit configuration, the quantum circuit configuration specifying a plurality of quantum gates, obtaining a set of implementable quantum gates, each of the implementable quantum gates corresponding to a quantum operation capable of being executed by hardware of a quantum computing device, determining a noise representation associated with a physical implementation of a target gate among the plurality of quantum gates, determining an inverse noise representation based on the noise representation, generating a generalized quasi-probabilistic decomposition of the inverse noise representation based on the set of implementable quantum gates, the generalized quasi-probabilistic decomposition including a positive component and a negative component, generating an updated quantum circuit configuration by inserting at least one implementable quantum gate subsequent to the target gate, wherein the at least one implementable quantum gate is selected from among the set of implementable quantum gates to correspond to the positive component of the generalized quasi-probabilistic decomposition, and wherein the negative component of the generalized quasi-probabilistic decomposition is excluded, transmitting the updated quantum circuit configuration to the quantum computing device for execution, and receiving an expectation value from the quantum computing device based on the execution of the updated quantum circuit configuration.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates a hybrid quantum-classical computer architecture according to an embodiment of the present disclosure.

FIG. 4 illustrates an example flow chart for a method of using inverse error mitigation by restricted evolution (EMRE) in a quantum computing device according to an embodiment of the present disclosure.

FIG. 5 illustrates a flowchart of a method for processing multiple quantum gates using inverse error mitigation by restricted evolution, according to an embodiment of the present disclosure.

FIG. 6 illustrates a block diagram of a hybrid quantum-classical system for inverse EMRE error mitigation, according to an embodiment of the present disclosure.

FIG. 7 illustrates a graph comparing the statistical variance of quantum measurement outcomes using different error mitigation techniques, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through the following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Also, the term device used herein can refer to a single device or a group of multiple devices that are connected together via wired connections or wireless connections.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Quantum computing is a field of computing that utilizes the principles of quantum mechanics to process and store information. At its core are quantum bits, or qubits, which can exist in multiple states simultaneously due to superposition. Unlike classical bits, which are strictly either 0 or 1, qubits can represent 0, 1, or any combination of both at the same time. This property allows quantum computers to perform numerous calculations simultaneously, potentially solving complex problems exponentially faster than classical computers.

Quantum computing can take advantage of any two-state quantum system. For example, qubits can be physically realized based on the spin of an electron, photon polarization, superconducting circuits, nuclear spin, trapped ions, defects in diamond crystals, and the like. Quantum computing also leverages entanglement, where the states of multiple qubits are interconnected, offering powerful computational capabilities (e.g., the computational state space scales exponentially by 2ⁿ, where n is the number of qubits).

Artificial intelligence (AI) refers to the field of studying and developing methodologies for creating artificial intelligence. Machine learning, a subset of AI, refers to the field of defining various issues dealt with in AI and studying methodologies for solving them. Machine learning is generally defined as an algorithm that enhances the performance of a certain task through steady experience or training data associated with that task.

An artificial neural network (ANN) is a model used in machine learning that represents a problem-solving architecture composed of artificial neurons (nodes) that form a network via synaptic connections. An artificial neural network can be defined by a connection pattern between neurons in different layers, a training process for updating model parameters, and an activation function for generating an output value.

In addition, a hybrid quantum-classical computer architecture can incorporate a neural network by combining the strengths of both classical and quantum computers to solve complex problems. The quantum component of the architecture can include qubits employed to execute specific quantum computations suited for tasks like quantum simulations, optimization, quantum chemistry, or material discovery (e.g., utilizing a QPU). The classical component of the architecture can include one or more CPUs or GPUs configured to handle tasks that are not well-suited for quantum processing, such as managing the overall computation, handling input/output, and running classical algorithms. Further, a neural network can be used to translate data and tasks between the CPU and the QPU, optimize the system, solve for parameters, and adjust parameters (e.g., minimizing a cost function).

An artificial neural network can include an input layer, an output layer, and optionally one or more hidden layers. Each layer includes one or more neurons, and synapses link the neurons together. In the artificial neural network, each neuron can output a function value of the activation function based on input signals, weights, and biases input through the synapses.

Model parameters refer to parameters determined through training and include synaptic connection weight values and neuronal biases. A hyperparameter refers to a parameter that is set in the machine learning algorithm prior to training, and includes variables such as a learning rate, a repetition number, a mini-batch size, and an initialization function.

The primary purpose of training an artificial neural network is to determine the model parameters that minimize a loss function. The loss function can be used as an index to determine optimal model parameters during the training process.

Machine learning can be broadly classified into supervised learning, unsupervised learning, and reinforcement learning, depending on the learning methodology.

Supervised learning can refer to a method of training an artificial neural network using labeled training data. The label represents the correct answer (or target result value) that the artificial neural network should learn to infer when the corresponding training data is input. Unsupervised learning refers to a method of training an artificial neural network using unlabeled data to find hidden structures or patterns. Reinforcement learning refers to a method in which an agent defined in a certain environment learns to select a behavior or sequence of behaviors that maximizes a cumulative reward in each state.

Machine learning models implemented as deep neural networks (DNNs), which include a plurality of hidden layers, are often referred to as deep learning models. In the following description, the term machine learning encompasses deep learning methodologies.

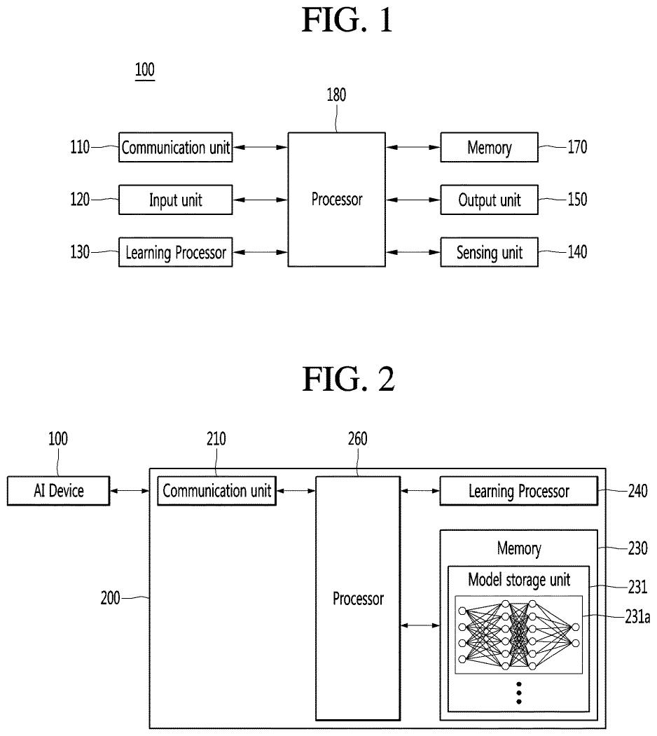

FIG. 1 illustrates an artificial intelligence (AI) device 100 which can be utilized as part of a hybrid quantum-classical computer architecture (e.g., executing the classical processing tasks), according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, digital signage, a robot, a vehicle, and the like. However, other variations are possible.

Referring to FIG. 1, the AI device 100 can include a communication unit 110 (e.g., a transceiver), an input unit 120 (e.g., a touchscreen, keyboard, mouse, microphone, etc.), a learning processor 130, a sensing unit 140 (e.g., one or more sensors or cameras), an output unit 150 (e.g., a display or speaker), a memory 170, and a processor 180 (e.g., a controller).

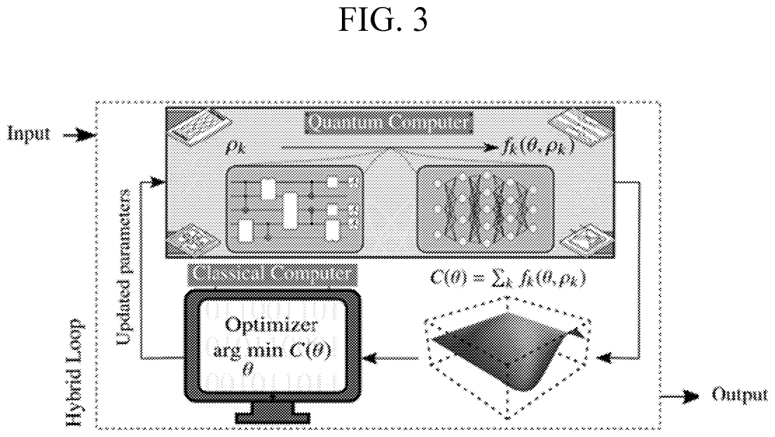

The communication unit 110 (e.g., communication interface or transceiver) can transmit and receive data to and from external devices such as other AI devices 100a to 100e and the AI server 200 (e.g., FIGS. 2 and 3) using wired/wireless communication technology. For example, the communication unit 110 can transmit and receive sensor information, user inputs, learning models, and control signals to and from external devices.

The communication technology utilized by the communication unit 110 can include GSM (Global System for Mobile communication), CDMA (Code Division Multi Access), LTE (Long Term Evolution), 5G, 6G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data. For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire training data for model learning and input data to be evaluated using a trained model. The input unit 120 can acquire raw input data. In this situation, the processor 180 or the learning processor 130 can extract an input feature by preprocessing the input data.

The learning processor 130 can train a model composed of an artificial neural network using the training data. The trained artificial neural network can be referred to as a learning model. The learning model can be used to infer a result value for new input data, and the inferred value can be used as a basis for determining a subsequent operation to perform.

For example, the learning processor 130 can perform AI processing tasks in conjunction with the learning processor 240 of the AI server 200.

In addition, the learning processor 130 can include memory integrated within or otherwise implemented in the AI device 100. Alternatively, the learning processor 130 can be implemented using the memory 170, an external memory directly connected to the AI device 100, or a memory held in a separate external device.

The sensing unit 140 can acquire internal information regarding the AI device 100, ambient environment information surrounding the AI device 100, and user information by utilizing various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

In addition, the output unit 150 can include a display unit for outputting visual information, a speaker for outputting auditory information, and a haptic module for outputting haptic feedback.

The memory 170 can store data that supports the various functions of the AI device 100. For example, the memory 170 can store input data acquired by the input unit 120, training data, trained models, learning histories, and the like.

The processor 180 can determine at least one executable operation of the AI device 100 based on information evaluated or generated using a data analysis algorithm or a machine learning algorithm. The processor 180 can control the components of the AI device 100 to execute the determined operation. For example, the processor 180 can evaluate logic rules to solve for parameters that are subsequently fed into a quantum circuit (e.g., determining rotation angles for physical quantum gates).

To this end, the processor 180 can request, search, receive, or utilize data from the learning processor 130 or the memory 170. The processor 180 can control the components of the AI device 100 to execute the predicted operation or the operation determined to be optimal among the executable operations.

When connection to an external device is desired to perform the determined operation, the processor 180 can generate a control signal for controlling the external device and transmit the generated control signal to the external device.

The processor 180 can acquire information from user inputs and determine an appropriate response, recommended item, or action based on the acquired intent information.

The processor 180 can process the user input utilizing at least one of a speech-to-text (STT) engine for converting speech input into a text string or a natural language processing (NLP) engine for determining the intention of the natural language input.

At least one of the STT engine or the NLP engine can be configured as an artificial neural network trained via machine learning algorithms. The STT engine or the NLP engine can be trained by the learning processor 130, by the learning processor 240 of the AI server 200 (see FIG. 2), or via distributed processing between the two.

The processor 180 can control the components of the AI device 100 to drive an application program stored in the memory 170. Furthermore, the processor 180 can operate two or more components included in the AI device 100 in combination to drive the application program.

FIG. 2 illustrates an AI server 200 according to one embodiment. The AI server can implement one or more components or tasks related to the classical computing portion of a hybrid quantum-classical computer architecture.

Referring to FIG. 2, the AI server 200 can refer to a device that trains an artificial neural network using a machine learning algorithm or utilizes a previously trained artificial neural network. The AI server 200 can include a plurality of servers configured for distributed processing, or can be defined over a 5G network, 6G network, or other communications network. Also, the AI server 200 can be included as a partial configuration of the AI device 100 to perform AI processing collaboratively.

The AI server 200 can include a communication unit 210, a memory 230, a learning processor 240, a processor 260, and the like.

The communication unit 210 can transmit and receive data to and from an external device, such as the AI device 100.

The memory 230 can include a model storage unit 231. The model storage unit 231 can store a model being trained or a fully trained model (e.g., an artificial neural network 231a) generated by the learning processor 240.

The learning processor 240 can train the artificial neural network 231a using training data. The learning model can be utilized while mounted on the AI server 200, or it can be transmitted and utilized on an external device such as the AI device 100.

The learning model can be implemented in hardware, software, or a combination of hardware and software. If all or part of the learning model is implemented in software, the instructions constituting the model can be stored in the memory 230.

The processor 260 can infer result values for new input data using the learning model and can generate responses or control commands based on the inferred values.

FIG. 3 illustrates a hybrid quantum-classical computer architecture according to an embodiment of the present disclosure.

The hybrid quantum-classical computer architecture can include a Quantum Processing Unit (QPU) and a Classical Processing Unit (CPU) interfaced to leverage the distinct advantages of both computing paradigms. The QPU includes qubits capable of superposition and entanglement, designed for executing quantum algorithms and operations to tackle complex problems with exponential speed-ups. Because the qubits can represent multiple states simultaneously, the QPU is highly effective for quantum simulations.

Conversely, the CPU manages classical computations, data input/output, and overall system control. An interface layer facilitates communication between the quantum and classical components, translating high-level tasks into quantum operations (e.g., specific microwave or optical pulse instructions), and converting quantum readouts back into classical data. This interface layer includes software, firmware, and protocols for optimizing performance and managing the hybrid workflow.

Quantum algorithms, such as variational quantum algorithms (VQA) and quantum chemistry simulations, can be run on the QPU to exploit quantum properties. Control software operating on the CPU oversees the hybrid system's operation, including managing error correction, noise mitigation protocols, and classical optimization routines required to update the quantum computation.

Because inherent noise and hardware errors significantly impact near-term quantum hardware, error correction and mitigation techniques can be integrated into the architecture. The hybrid architecture can also include an application layer providing user interface software, enabling interaction with the system to input problems, receive results, and analyze mitigated data.

In more detail, the classical computer can include an optimizer or optimization function configured to implement a cost function (or objective function). The cost function can be optimized using various techniques, such as gradient descent, though embodiments are not limited thereto. The optimizer can utilize various hyperparameters, such as step size and iteration counts, to dictate how the system converges on a minimum.

This type of hybrid quantum-classical computer architecture can be referred to as a near-term quantum computer, a noisy intermediate-scale quantum (NISQ) computer, or a NISQ device.

NISQ algorithms can be designed for short-depth quantum circuits with limited numbers of qubits and gates (e.g., VQAs), as deeper circuits may quickly become overwhelmed by uncorrected hardware noise.

Optimization problems frequently arise in physics, mathematics, and computer science. The problem of finding the ground state of a given Hamiltonian is one such problem that can be cast as an optimization task. VQAs can utilize noisy quantum computers in tandem with classical optimization loops to address these problems and achieve near-term quantum advantage. For example, VQAs can be used to efficiently find the ground state of a Hamiltonian or to execute diffusion quantum Monte Carlo simulations.

Various operations can be applied to the qubits during these algorithms. For example, specific quantum gates trigger physical rotations around certain axes (e.g., RY gates for rotating a qubit's state vector).

Following gate execution, physical measurements can be performed on the qubits. These measurements provide information about the current state's proximity to the target ground state, determining how effectively the system is evolving toward the desired solution.

Based on these measurements and the classical cost function, the classical computer can solve for updated parameters and apply those updates to the quantum gates for the next circuit run. In this way, the guess for finding the ground state (e.g., the lowest energy state) can be iteratively refined. This feedback loop is repeated, allowing the hybrid system to gradually converge to the ground state.

According to certain embodiments, the classical computer can utilize an artificial intelligence (AI) model (e.g., a neural network) to solve for the updated parameters of the quantum circuit.

The classical computer can determine whether the system has converged to the desired state. If convergence is not reached, the process repeats, e.g., the quantum circuit is updated with a new set of parameters (e.g., updated theta values), and the circuit is executed again. The process iterates until convergence is achieved, generating a final output result.

This final result (e.g., the calculated ground state of a quantum system) is highly valuable for simulations across various fields, including quantum chemistry, material science, physics, and cryptography. For instance, successfully calculating the ground state of a molecule provides insights into its electronic structure, bond energies, and reaction mechanisms, which can be used for drug discovery and material design.

However, in NISQ devices, this final result is often unreliable due to the physical noise present in the system. Addressing this noise to prevent computational errors often uses mitigation techniques that have historically been exceedingly time consuming, resource intensive, or mathematically biased.

Removing or mitigating noise remains a considerable challenge in quantum computation. While full quantum error-correction schemes can theoretically detect and correct noise, they require complex encoding and decoding protocols. To deliver meaningful results, these fault-tolerant schemes necessitate thousands to millions of physical qubits, placing them beyond the reach of current NISQ hardware capabilities.

Instead of full error correction, various types of quantum error mitigation (QEM) can be applied to improve the measurement outcome of the expectation value, such as zero-noise extrapolation (ZNE), probabilistic error cancellation (PEC), and Clifford-data regression.

When evaluating different error mitigation protocols, three primary performance metrics can be examined, such as the number of ancilla qubits required, the amount of bias present in the final estimate, and the sampling overhead required to achieve the result. Sampling overhead is closely related to statistical variance. Bias and variance can be defined as shown in Equation 1 and Equation 2, respectively.

Bias=E[Ô]−Tr[Oρ] [Equation 1]

Var=E[Ô²]−E[Ô]² [Equation 2]

Engineering a practical error mitigation calls for navigating the bias-variance tradeoff, e.g., finding a practical balance between the algorithm's accuracy (bias) and its statistical stability (variance). Protocols that introduce high bias may miss important computational details, while protocols with high variance require an impractical number of hardware sampling shots to achieve a reliable average. A practical mitigation algorithm should find a middle ground that minimizes computational sampling intensity while providing sufficiently accurate results.

Zero-noise extrapolation (ZNE) operates by systematically amplifying the noise present in a quantum computer in a controlled manner, taking measurements at those elevated noise levels, and then mathematically extrapolating the results back to a theoretical zero-noise limit (e.g., plotting a line with increased noise, and then traversing it backwards).

For instance, ZNE includes running the same quantum circuit many times with varying noise amplification factors, measuring the outcomes, and fitting a curve to the data that relates the noise level to the measured expectation values. By extrapolating this curve backwards to the y-intercept (where noise equals zero), the ideal noise-free outcome can be estimated.

However, while ZNE can effectively mitigate certain errors, it requires significant computational overhead due to the necessity of running the circuit at multiple different noise levels. Furthermore, ZNE relies on specific extrapolation techniques that may not accurately capture complex hardware behavior, the intentional amplification of noise can sometimes introduce new, unpredictable errors, and ZNE fundamentally yields a biased result.

Conversely, theoretical Probabilistic Error Cancellation (PEC) is designed to produce completely unbiased results, however, it achieves this theoretical purity at the cost of exponential sampling overhead and exponential runtime. Theoretical PEC leverages a known mathematical model of the hardware noise to actively cancel errors during computation.

The PEC process can include characterizing the noise present in a quantum circuit, constructing a mathematical model of that noise, and using the model to generate a quasi-probability distribution that describes the required mitigation steps.

For example, by creating a mathematical model that predicts how hardware errors affect the qubits, PEC can probabilistically inject inverse operations (e.g., applying an inverse noise map) into the quantum circuit. By running the quantum circuit multiple times with these randomized, added gate operations and averaging the results, the physical hardware errors and the injected operations cancel each other out, producing an unbiased expectation value.

To achieve this, each noisy unitary gate in the quantum circuit is mathematically decomposed into a quasi-probabilistic linear combination of a discrete set of implementable basis gates (e.g., Pauli gates). Finding this exact decomposition requires complex classical computation.

Once the decomposition is calculated, the quantum computer executes the circuit by randomly sampling and inserting the implementable gates according to the calculated distribution. By utilizing Monte Carlo sampling over many circuit runs, an unbiased estimate is calculated. However, the runtime required to shrink the statistical variance depends on a mathematical quantity called the “sampling overhead” or “robustness,” which is dictated by the sum of the absolute values of the coefficients in the quasi-probabilistic decomposition.

Because these theoretical decompositions inevitably contain negative coefficients (a phenomenon that can be referred to as the “sign problem”), tracking the parity signs during theoretical PEC causes the statistical variance to explode. Consequently, theoretical PEC requires exponential sampling overhead and exponential runtime to achieve a reliable average, quickly destroying any quantum advantage as the depth of the quantum circuit increases.

To better understand the specific computational bottlenecks addressed by the present disclosure, an example workflow for applying theoretical PEC to one or more quantum gates within a quantum circuit generally proceeds as follows.

For example, a PEC workflow can include five main steps, such as characterizing the noise, creating a noise model, generating a quasi-probabilistic distribution (which fundamentally includes both positive probability components and negative probability components), probabilistic sampling, and averaging the results.

First, a classical computing system receives a target quantum circuit and should obtain an accurate characterization of the hardware noise affecting that circuit. In related methods, this characterization is often a theoretical approximation based on generalized statistical tools, gate error rates, and coherence times.

Based on this theoretical characterization, a generalized noise model is selected or generated (e.g., a depolarizing noise model, amplitude damping, stochastic Pauli noise, bit-flip noise, etc.). This mathematical model represents an assumption of how noise affects the quantum states.

Next, a full quasi-probabilistic distribution is generated for each target quantum gate based on the assumed noise model. This quasi-probabilistic distribution includes negative or complex values. While finding this distribution can theoretically be obtained based on the Choi matrix or full process tomography, doing so dynamically for every gate is highly resource-intensive.

The system then generates an updated quantum circuit in which the target quantum gate is replaced by operations sampled from this full, positive-and-negative quasi-probabilistic distribution.

The quantum computing device can execute the updated quantum circuit multiple times (e.g., utilizing Monte Carlo sampling) with different random variations dictated by the full distribution to generate a large set of raw measurement results.

Finally, the results of the different runs can be averaged to calculate the estimated expectation value. However, because the related sampling process includes the negative probability components, the results swing wildly between positive and negative extremes. Thus, an exponentially large number of circuit runs are required before the noise is effectively canceled out and a stable average emerges, rendering the related PEC example impractical for complex hardware implementations.

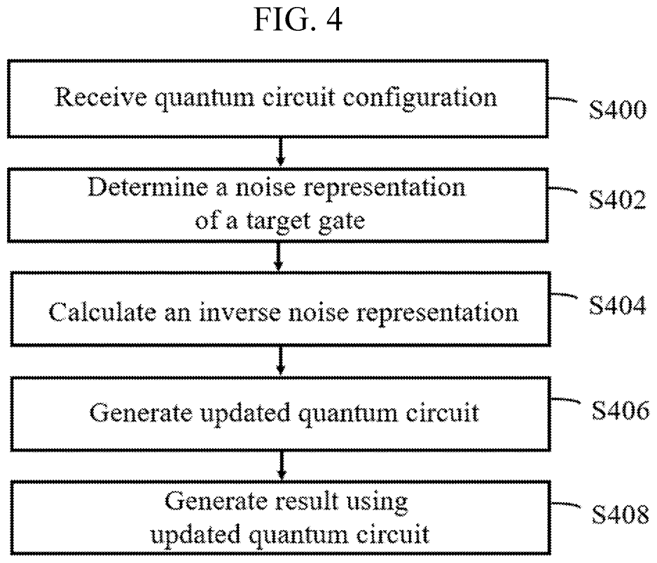

FIG. 4 shows an example flow chart of a method for mitigating error in a quantum computing device according to an embodiment of the present disclosure. For example, the AI device 100 can be configured with a method that includes receiving a quantum circuit configuration including a plurality of quantum gates (e.g., S400). The received quantum circuit configuration represents a desired quantum algorithm or computation and includes a plurality of quantum gates intended for execution on the physical quantum hardware.

In step S402, the method includes determining a physical noise representation associated with a physical implementation of a target gate (e.g., an erroneous gate) among the plurality of quantum gates. Because physical quantum hardware is susceptible to complex and dynamic environmental interactions, the target gate can be physically characterized rather than relying solely on theoretical assumptions.

According to an embodiment, determining the noise representation can include generating a measured Pauli transfer matrix (PTM) of the physical target gate through tomographic characterization. Then, a specific noise matrix (e.g., the noise representation) can be extracted by multiplying the measured transfer matrix by an inverse of an ideal transfer matrix corresponding to that target gate. This process can effectively isolate the specific physical noise channel affecting the target gate during hardware execution.

In step S404, the method includes calculating an inverse noise representation based on the determined noise representation from step S402. By determining the mathematical inverse of the extracted noise matrix, the AI device 100 can calculate a restorative mathematical operation designed to counteract the specific hardware noise of the target gate.

In step S406, the method includes generating an updated quantum circuit configuration by inserting at least one implementable quantum gate subsequent to the target gate to counteract the noise.

For example, the at least one implementable quantum gate can be selected from among a set of physically implementable quantum gates based on a generalized quasi-probabilistic decomposition of the inverse noise representation.

According to an embodiment, the generalized quasi-probabilistic decomposition includes a positive component, and a negative component of the generalized quasi-probabilistic decomposition can be entirely excluded. By intentionally excluding the negative components of the generalized quasi-probabilistic decomposition, the method can drastically reduce the sampling overhead associated with executing the updated quantum circuit configuration by eliminating the need for parity sign tracking.

In step S408, the method includes generating a result using the updated quantum circuit. For example, the method includes executing the updated quantum circuit configuration to generate an error-mitigated expectation value. Because the updated quantum circuit configuration is constructed using only the positive probability components of the inverse noise representation, the AI device 100 can perform a stochastic execution over a plurality of iterations to compute a stable expectation value without incurring the exponential statistical variance typically caused by tracking negative parity signs. Various aspects of the method are discussed in more detail below, according to embodiments.

To further illustrate the inverse error mitigation by restricted evolution (Inverse EMRE) technique, the following section details a simplified example of the method applied to a quantum circuit having a single target gate, denoted as ideal gate G, according to an embodiment.

In a physical quantum computing environment, it is difficult to execute the ideal gate G perfectly. Instead, the hardware executes an erroneous gate, denoted as G^{err}, which can be mathematically modeled as the ideal gate G followed by a physical noise channel E. This relationship is expressed as G^{err}=E∘G.

In order to extract the ideal computational result from the implemented erroneous gate G^{err}, the system theoretically applies an operation that reverses the action of the physical error channel E. Mathematically, applying the inverse noise channel E⁻¹ to the erroneous gate yields the ideal execution: G=E⁻¹∘G^{err}.

However, achieving this in practice presents two primary challenges. First, the exact hardware noise E occurring in the physical quantum device is like a black box and is generally unknown prior to execution. Second, even if the noise channel E were perfectly known, the pure mathematical inverse E⁻¹ often represents a non-physical operation that cannot be natively implemented using standard quantum hardware gates. The present disclosure provides a practical, hardware derived scheme to resolve both challenges and approximate the ideal computational results.

According to an embodiment, a first step can include characterizing the target gate by computing a measured transfer matrix, such as a Pauli Transfer Matrix (PTM), of the physical erroneous gate G^{err}.

For example, the PTM can be a d²×d² matrix representation of a quantum operation that encodes all information about how that gate transforms quantum states. Here, d=2ⁿ, where n is the number of qubits the gate acts upon, meaning the total number of Pauli operators for an n-qubit system is d²=4ⁿ.

For a single-qubit target gate (n=1), the basis set of Pauli gates is {I, X, Y, Z}. For multi-qubit gates, the basis set is constructed using the tensor products of these n Pauli matrices. To calculate the (i, j)-th matrix element of the PTM for a given gate operation G, the AI device 100 utilizes the i-th and j-th Pauli operators and computes the following normalized trace, according to Equation 3 below.

$${R}_{i , j}^{G} = \frac{T r [ {P}_{i} G ( {P}_{j} ) ]}{{2}^{n}} \qquad [ Equation 3 ]$$

According to an embodiment, these PTM elements can be computed experimentally directly on the quantum hardware. By expressing the Pauli operators in terms of quantum states and performing quantum state tomography and Pauli measurements, the classical computing subsystem can reconstruct the exact physical behavior of the gate.

Thus, the AI device 100 experimentally computes the elements of the physical erroneous gate G^{err} to output the measured Pauli transfer matrix, R^{G}^{^{err}}.

The second step can include extracting the Pauli Transfer Matrix of the specific hardware noise, denoted as R^{E}. Because the user's intended quantum circuit configuration is known, the AI device 100 can compute the PTM of the ideal gate, R^{G}, using classical simulation.

Having acquired both the ideal transfer matrix R^{G} and the measured transfer matrix R^{G}^{^{err}}, the system can isolate the PTM of the noise. Because the relationship G^{err}=E∘G can be expressed linearly in terms of PTMs as R^{G}^{^{err}}=R^{E}∘R^{G}, the AI device 100 can calculate the noise matrix R^{E} by multiplying the measured transfer matrix R^{G}^{^{err}} by the inverse of the ideal transfer matrix R^{E}^{^{−1}}.

The third step can include calculating the inverse noise representation and generating its generalized quasi-probabilistic decomposition. Once the noise matrix R^{E} is isolated, the AI device 100 can compute its mathematical inverse, R^{E}^{^{−1}}, which is the PTM of the inverse noise channel.

Then, the AI device 100 can express this inverse noise channel as a generalized quasi-probabilistic decomposition of physically implementable Pauli errors. This decomposition is mathematically represented as Equation 4, below.

$${R}^{{E}^{- 1}} = {\sum }_{i} {a}_{i} {P}_{i} - b ℳ = s {\sum }_{i} {p}_{i} {P}_{i} - ( s - 1 ) ℳ \qquad [ Equation 4 ]$$

In the above Equation 4, which can be computed by classical linear algebra solvers, the inverse noise is decomposed into a positive component (sΣᵢpᵢPᵢ) and a negative component ((s−1)M). Here, s is the scaling factor defined as the sum of all coefficients aᵢ (e.g., s=>Σᵢaᵢ). Each individual positive weight pᵢ is calculated such that aᵢ=spᵢ, ensuring that the set of all pᵢ's constitutes a strictly valid probability distribution where Σᵢpᵢ=1. The negative component coefficient b is mathematically rewritten as (s−1).

Further in this example, to achieve error mitigation by restricted evolution (EMRE) and bypass the sampling overhead associated with tracking negative parity signs, the AI device 100 strictly drops or excludes the negative component ((s−1)M) from the decomposition. Consequently, the AI device 100 retains only the positive component comprising the strictly-positive probability distribution {pᵢ} of implementable Pauli gates Pᵢ.

The fourth step can include stochastically executing the updated quantum circuit to perform the EMRE mitigation. To mitigate the errors during runtime, the AI device 100 can dynamically insert at least one implementable quantum gate (e.g., a Pauli gate Pᵢ) immediately subsequent to the physical execution of the erroneous gate G^{err}.

For each run of the circuit, this implementable gate Pᵢ is probabilistically sampled from the set of all available Pauli gates based solely on the positive probability distribution {pᵢ}.

The AI device 100 repeats this stochastic execution over a plurality of iterations to generate a distribution of measurement outcomes. The AI device 100 then averages these outcomes to compute an expectation value of the targeted observable.

Then, the AI device 100 can scale the averaged expectation value by multiplying it by the scaling factor s to output the final, error-mitigated expectation value. Because the negative components were excluded from the sampling distribution, the exponential statistical variance is completely avoided, allowing the method to achieve highly accurate error mitigation in constant runtime.

While certain embodiments are described herein with respect to a single target gate for clarity, the quantum circuit configuration can include a plurality of target gates (e.g., a plurality of two-qubit entangling gates interspersed with single-qubit gates).

For example, according to an embodiment, the AI device 100 is configured to independently determine a measured noise representation, calculate an inverse noise representation, and generate a positive quasi-probabilistic decomposition for each of the plurality of target gates respectively. During execution, a stochastic circuit scheduler can dynamically insert implementable quantum gates corresponding to the respective positive components at each target gate location throughout the circuit.

While certain example embodiments describe generating the updated quantum circuit configuration by inserting the at least one implementable quantum gate subsequent to (e.g., immediately following) the target gate, the present disclosure is not limited thereto. In alternative embodiments, the inverse noise representation can be decomposed and the corresponding implementable quantum gate can be inserted prior to the target gate (e.g., as a pre-mitigation step).

Furthermore, the inverse noise representation can be symmetrically or asymmetrically split, such that a first portion of the sampled implementable quantum gate is inserted prior to the target gate and a second portion is inserted subsequent to the target gate, thereby sandwiching the noisy target gate to mitigate complex, time-dependent noise operations.

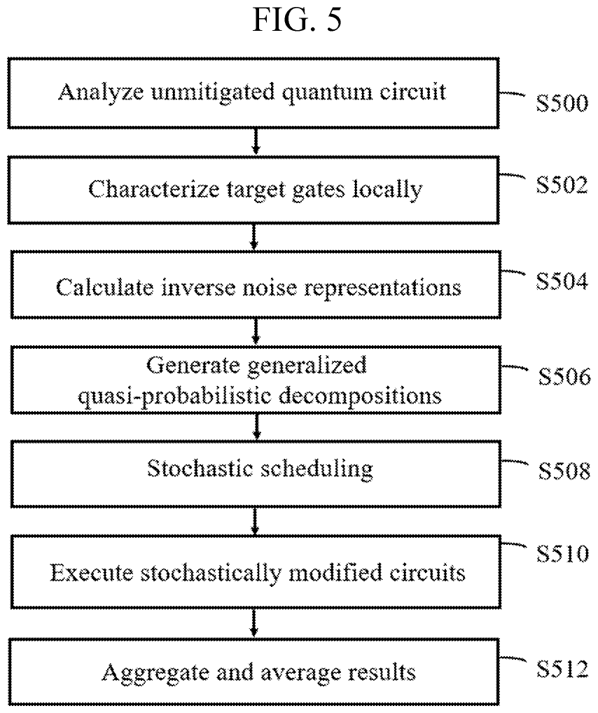

FIG. 5 illustrates a flowchart of a method for processing multiple quantum gates using inverse error mitigation by restricted evolution, according to an embodiment of the present disclosure.

Referring to FIG. 5, in step S500, the AI device 100 can analyze an unmitigated circuit. For example, a classical computing subsystem or controller of the AI device 100 can receive a user input circuit and identify a plurality of target gates for error mitigation within that circuit.

In some embodiments, the AI device 100 can selectively target specific types of gates that are highly susceptible to physical hardware noise, such as multi-qubit gates (e.g., controlled-NOT or CNOT gates), while strategically skipping lower noise single-qubit gates to optimize processing resources and reduce overall computational overhead. However, embodiments are not limited thereto and all the gates in the quantum circuit can be set as target gates according to design considerations.

In another embodiment, the AI device 100 can dynamically select the target gates based on a predefined error threshold. During the initial characterization phase, if the extracted noise matrix for a specific gate indicates an error rate falling below the predefined threshold, the system can dynamically bypass the generation of the inverse noise representation and stochastic insertion for that specific gate, thereby adaptively conserving computational resources and reducing circuit depth during runtime.

In step S502, the AI device 100 can locally characterize the identified target gates. For each target gate, the AI device 100 can execute on-hardware tomographic protocols. By utilizing techniques such as gate set tomography, the AI device 100 can extract a specific, measured transfer matrix that accurately represents the physical, noisy execution of that specific gate on the physical hardware.

In step S504, the AI device 100 can calculate an inverse noise representation for each target gate. For each respective target gate, the AI device 100 can retrieve a corresponding ideal transfer matrix from memory. The AI device 100 then mathematically isolates the specific empirical inverse noise channel. This can be achieved by determining the hardware noise (e.g., by multiplying the measured transfer matrix by an inverse of the ideal transfer matrix) and calculating a mathematical inverse of that isolated noise channel.

In step S506, the AI device 100 can generate strictly-positive quasi-probabilistic decompositions for each characterized target gate. For each calculated inverse noise channel, the AI device 100 can express the mathematical operation as a linear combination of physically implementable basis gates.

Further in this example, according to an embodiment, the AI device 100 can intentionally discard all negative coefficients from the linear combination and re-normalize the remaining positive weights. This mathematical truncation can create a distinct, strictly-positive probability distribution for each targeted gate location, effectively eliminating the mathematical components that cause exponential sampling overhead. However, embodiments of the present disclosure are not limited thereto. For example, according to an embodiment, one or more negative components can be intentionally retained in the generalized quasi-probabilistic decomposition to further improve the computational accuracy of the error mitigation. Retaining these negative components, however, will correspondingly increase the computation cost and sampling overhead required to execute the updated quantum circuit configuration.

In step S508, the AI device 100 performs stochastic scheduling. For example, this step can utilize Monte Carlo sampling techniques to compile unique circuit configurations for a plurality of hardware shots.

For each individual shot or iteration, the AI device 100 can execute a randomized selection process (e.g., rolling digital dice) based on the specific strictly-positive probability distribution generated for each target gate location. Based on this randomized selection, the AI device 100 dynamically inserts a sampled, physically implementable quantum gate (such as a Pauli gate) immediately subsequent to each targeted gate in the circuit configuration.

While the stochastic scheduling can utilize standard Monte Carlo sampling, the present disclosure is not limited thereto. In alternative embodiments, the system can employ quasi-Monte Carlo sampling, stratified sampling, or importance sampling to dynamically select the implementable quantum gates from the strictly-positive probability distribution. These advanced sampling techniques can further accelerate the convergence of the expectation value by ensuring a more uniform distribution of the inserted physical operations across the plurality of hardware shots.

As used herein, the term “implementable quantum gate” can refer to a natively executable physical operation, or a predefined physical sequence of natively executable operations, that the hardware of the quantum computing device is physically configured to perform. Because quantum hardware modalities (such as superconducting transmons, trapped ions, or neutral atoms) possess limited sets of physical control mechanisms (e.g., specific microwave pulses or laser arrays), theoretical quantum operations often cannot be executed directly. Therefore, an implementable quantum gate is an operation selected from a limited hardware specific basis gate set that can be applied to the physical qubits with high fidelity. By way of example and not limitation, an implementable quantum gate can include single-qubit native hardware gates, two-qubit native entangling gates (e.g., such as a controlled-NOT (CNOT) gate, a controlled-Z (CZ) gate, or an iSWAP gate), or Pauli gates (e.g., such as Pauli-X, Pauli-Y, Pauli-Z, and the Identity gate) which can be heavily utilized as basis states during quasi-probabilistic decomposition.

In step S510, the AI device 100 executes the stochastically modified circuits. The quantum computing hardware runs a large volume (e.g., thousands) of these dynamically generated circuit iterations. Because the negative probability components were entirely excluded during the decomposition phase, these iterations remain completely variance controlled and are executed without incurring the exponential statistical variance associated with parity sign tracking.

In step S512, the AI device 100 can aggregate and average the computational results. A classical computing subsystem of the AI device 100 can collect the measurement outcomes from all of the executed iterations. Since the explosive statistical variance was bypassed at each local gate step through the use of the strictly-positive probability distributions, the AI device 100 can efficiently combine these outcomes to compute and output a final, highly accurate average mitigated expectation value.

The final, highly accurate average mitigated expectation value generated in step S512 can serve as an important building block for a variety of downstream hybrid quantum-classical algorithms.

For example, in many practical near-term quantum computing applications, the quantum hardware is utilized as a specialized co-processor to measure a physical observable or evaluate a cost function, while a classical optimizer iteratively updates the circuit parameters based on that evaluation. Because the inverse EMRE technique provides a high-fidelity expectation value while bypassing exponential sampling overhead, these hybrid algorithms can converge more rapidly and prevent the algorithm from stalling or getting stuck due to hardware noise.

According to an embodiment, the mitigated expectation value can be utilized in quantum chemistry and materials science downstream tasks, such as executing a Variational Quantum Eigensolver (VQE) algorithm.

In a VQE application, the expectation value represents the energy state of a molecular Hamiltonian. By utilizing the inverse EMRE method to highly accurately estimate the ground state energy of complex molecular structures (e.g., in advanced battery electrolytes, pharmaceutical drug interactions, etc.) a classical computing system can simulate physical and chemical properties that are fundamentally intractable for classical supercomputers.

According to another embodiment, the mitigated expectation value can be utilized in complex combinatorial optimization tasks or quantum machine learning (QML) applications. For example, when employing the Quantum Approximate Optimization Algorithm (QAOA) for large scale telecommunications network design, supply chain logistics, or financial portfolio optimization, the expectation value corresponds to the cost function of the optimization problem.

Additionally, in QML environments, the mitigated expectation value can be utilized as a precise gradient or loss metric fed into a classical neural network training loop. By ensuring the gradient estimations are highly accurate and largely free from unmitigated hardware noise, the AI device 100 can reliably accelerate the training and fine-tuning of generative AI modules or other complex language model architectures.

In addition, although the noise representation can be extracted using a measured transfer matrix via an on-hardware gate set tomography (GST) protocol, the present disclosure is not limited to this specific technique. In various alternative embodiments, determining the noise representation can include utilizing randomized benchmarking (RB), interleaved randomized benchmarking (IRB), cycle error extrapolation, Pauli Lindblad noise characterization, or quantum process tomography (QPT). Any physical protocol capable of characterizing the difference between the physical implementation of the target gate and its ideal mathematical unitary can be utilized by the system to determine the noise representation.

In addition, in some embodiments, instead of dynamically executing physical probing protocols (such as GST) for every circuit execution, the AI device 100 can utilize a trained machine learning model to determine the noise representation. For example, the AI device 100 can continuously collect historical calibration data, temperature fluctuations, and cross-talk metrics from the quantum computing device. A neural network or regression model executing on the controller of the AI device can ingest this historical data to predict the real-time noise representation (e.g., a predicted noise matrix) for the target gate at the exact time of execution, thereby bypassing active measurement and reducing overall latency.

Also, the controller of the AI device 100 be implemented across various levels of a classical-quantum computing stack. In one embodiment, the AI device 100 can operate as a remote cloud-based server that receives the circuit specification, compiles the updated quantum circuit configuration, and transmits it over a network to a distinct quantum hardware provider.

In an alternative embodiment, the AI device 100 and its controller can be tightly integrated into the local control electronics of the quantum computing device itself, such as being embodied within a Field Programmable Gate Array (FPGA), an Application-Specific Integrated Circuit (ASIC), or an Arbitrary Waveform Generator (AWG) that directly orchestrates the analog microwave or laser pulses applied to the physical qubits.

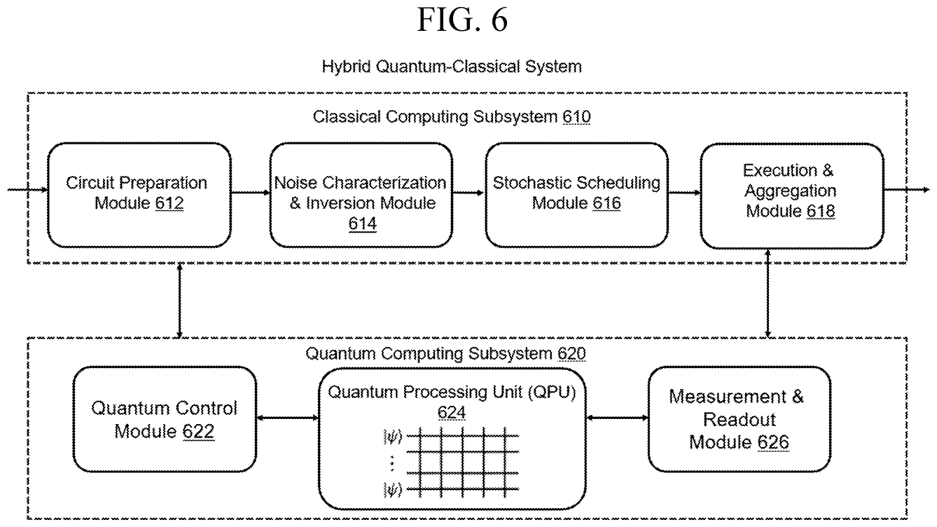

FIG. 6 illustrates a block diagram of a hybrid quantum-classical system for inverse EMRE error mitigation, according to an embodiment of the present disclosure.

Referring to FIG. 6, the overall system can include a Classical Computing Subsystem 610 and a Quantum Computing Subsystem 620, which are bidirectionally connected for system control and data flow. The Classical Computing Subsystem 610 can be configured to perform the algorithmic, mathematical, and scheduling operations of the error mitigation process (e.g., steps S500-S508 of FIG. 5). The Quantum Computing Subsystem 620 can be configured to execute the compiled quantum circuits, and the variance-controlled execution of the stochastically modified circuits (e.g., step S510 of FIG. 5).

According to an embodiment, the AI device 100 can include all components of the hybrid quantum-classical system integrated within a single physical unit or local environment. However, embodiments of the present disclosure are not limited thereto. In various embodiments, one or more components of the system can be implemented locally, while other components can be located remotely and accessed via a communication network.

For example, the functional modules of the Classical Computing Subsystem 610 can be executed on a local user workstation or a distributed cloud server, while the physical hardware of the Quantum Computing Subsystem 620 can be housed in a separate, specialized facility and accessed remotely over a wired or wireless network to execute the compiled quantum circuits.

Further in this example, the Classical Computing Subsystem 610 contains several interconnected functional modules. A Circuit Preparation Module 612 receives the unmitigated circuit input, parses the circuit logic, and identifies the multi-qubit gates targeted for error mitigation (e.g., performing step S500 of FIG. 5). A Noise Characterization & Inversion Module 614 can bidirectionally interface with the Quantum Computing Subsystem 620. The Noise Characterization & Inversion Module 614 can be configured to trigger the tomographic characterization sequences on the hardware, retrieve the resulting raw noisy data, and classically compute the isolated inverse noise representations for each target gate location (e.g., performing steps S502 and S504 of FIG. 5).

A Stochastic Scheduling Module 616 can receive the inverse noise representations. For example, the Stochastic Scheduling Module 616 can be configured to generate the generalized quasi-probabilistic decompositions, discard the negative probability components to form strictly-positive probability distributions, and classically roll digital dice (Monte Carlo sampling) to compile the thousands of uniquely modified circuit configurations (e.g., performing steps S506 and S508 of FIG. 5).

In addition, an Execution & Aggregation Module 618 can receive the stochastically scheduled circuit configurations. The Execution & Aggregation Module 618 can be configured to manage the deployment of these configurations to the Quantum Computing Subsystem 620 for execution, receive the resulting measurement outcomes from the hardware, and aggregate them to compute and output the final, error-mitigated expectation value (e.g., managing step S510 and performing step S512 of FIG. 5).

The Quantum Computing Subsystem 620 can include physical hardware components and associated control electronics. A Quantum Control Module 622 can receive digital control signals and compiled circuit configurations from the classical subsystem, translate them into precise physical control pulses (e.g., microwave or RF signals), and bidirectionally connects to the QPU 624.

Also, the Quantum Processing Unit (QPU) 624 houses the physical qubits (e.g., superconducting transmons) and executes the physical quantum operations as driven by the control signals.

Further, a Measurement & Readout Module 626 can connect bidirectionally to the QPU 624. At the conclusion of a circuit iteration, the Measurement & Readout Module 626 can probe the qubits to collapse their states, digitize the physical signals, and transmit the resulting raw measurement outcomes (classical bit strings) back to the Execution & Aggregation Module 618 in the classical subsystem.

In some embodiments, the inverse EMRE protocol can be executed as part of a multi-layered hybrid mitigation pipeline. For instance, after the Execution & Aggregation Module 618 receives the raw measurement outcomes (e.g., classical bit strings) from the Measurement & Readout Module 626, the system can apply a classical Readout Error Mitigation (REM) matrix to the outcomes prior to or during the averaging step. This combined approach can simultaneously neutralize both the in-circuit operational noise via restricted evolution and the backend measurement readout errors.

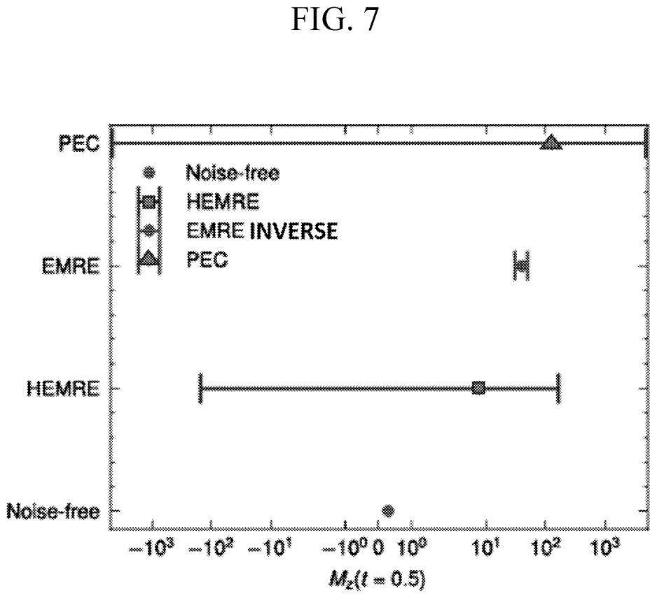

FIG. 7 illustrates a graph comparing the statistical variance of quantum measurement outcomes using different error mitigation techniques, according to an embodiment of the present disclosure.

Referring to FIG. 7, the plot demonstrates the technical advantage of the disclosed inverse error mitigation by restricted evolution (EMRE) techniques over standard probabilistic error cancellation (PEC). For instance, experimental results were obtained by combining the disclosed inverse technique for PEC, HEMRE and EMRE mitigation protocols.

In the illustrated graph in FIG. 7, a noise-free ideal baseline is represented by a dot without error bars. Theoretical PEC is represented by a triangle with associated error bars. A hybrid EMRE (HEMRE) technique is represented by a square with associated error bars, and the disclosed inverse EMRE technique is represented by a dot with associated error bars.

As shown by the respective markers and their error bars, applying theoretical PEC (the triangle) to the noisy quantum circuit results in a massive statistical variance explosion. This variance explosion requires an exponentially larger number of sampling shots to resolve a meaningful expectation value.

In contrast to PEC, the data point representing the disclosed inverse EMRE technique (the dot with error bars) exhibits tightly constrained variance, plotting closely to the noise-free ideal baseline.

By intentionally discarding the negative probability components during the quasi-probabilistic decomposition of the inverse noise channel, the AI device 100 can effectively eliminate the sampling overhead associated with parity sign tracking. In this way, the system can compute a highly accurate, error-mitigated expectation value without suffering from the variance-induced performance bottlenecks inherent to related methods.

According to an embodiment, the AI device 100 can be configured with a hybrid computing framework to achieve highly accurate, error mitigated quantum measurements by bypassing the statistical variance limitations inherent to near-term quantum hardware. The AI device 100 can be implemented across a wide variety of domains, including, but not limited to, quantum chemistry, materials science, artificial intelligence, and cryptography.

According to one or more embodiments of the present disclosure, the method and hybrid quantum computing framework can solve one or more technological problems in existing quantum computing technology, namely the inability to reliably determine an expectation value of a physical observable without succumbing to exponential computational overhead caused by hardware noise.

For example, embodiments of the present disclosure can address the deficiencies of related art probabilistic error cancellation (PEC) methods, which suffer from a fundamental inability to scale. Standard error mitigation methods require the tracking of negative parity signs during quasi-probabilistic decomposition, leading to an explosion in statistical variance. This variance explosion results in an intractable, exponential runtime that paralyzes hybrid quantum-classical algorithms and consumes vast amounts of processing resources.

To overcome these technical deficiencies, the AI device 100 provides a hardware-level solution that drastically reduces processing times and conserves quantum computing resources. By implementing inverse error mitigation by restricted evolution (EMRE) to isolate and mathematically discard negative probability components, the system can utilize strictly positive probability distributions. This elegant physical execution transforms an intractable exponential runtime problem into a scalable, variance controlled execution that allows the quantum hardware to reliably determine the expectation value in near constant runtime.

Also, according to an embodiment, the AI device 100 configured with the disclosed method can be accessed or utilized via a variety of client terminals and edge devices, including a mobile terminal, a smart device, or an automated robotic system, which can communicate with a quantum computing backend or cloud infrastructure to request specific error mitigated circuit executions.

The reliable, variance free expectation values generated by the AI device 100 can be used to execute a wide range of advanced computational applications. For instance, in materials science and quantum chemistry, calculating the ground state for complex molecules provides important insights into their electronic structures, bond energies and reaction mechanisms. This highly accurate quantum mechanical mapping is useful for developing next generation physical materials, such as highly efficient fluorescent or phosphorescent compounds utilized in advanced OLED and Micro LED display technologies, or discovering novel superconducting topologies for future computing architectures.

Furthermore, the optimized solutions generated by the classical optimizer utilizing the variance controlled expectation value can be deployed in advanced graphical or spatial computing domains. For example, the hybrid quantum-classical algorithms can utilize the mitigated results to optimize complex physical routing within advanced display circuits, accelerate the real-time processing pipelines for hyper-realistic digital avatars, or execute high-dimensional matrix operations for complex 3D animation, where classical computing resources are traditionally bottlenecked.

According to another embodiment, the automated laboratory robot or client terminal can utilize the precisely mitigated quantum mechanical properties of a newly synthesized molecule to perform a physical testing or screening action, such as executing complex chemical reactions, performing compound filtering for automated drug discovery, or identifying highly targeted therapeutics without suffering from noise induced prediction errors.

Furthermore, the disclosed method provides significant advantages for the field of artificial intelligence. The highly accurate, error mitigated expectation value can be utilized as a precise gradient or cost function metric fed into a classical neural network training loop. By ensuring the gradient estimations are highly accurate and free from exponential statistical explosions, the AI device 100 can reliably accelerate the training and fine-tuning of generative artificial intelligence modules, quantum machine learning (QML) models, and complex language model architectures.

In an enterprise or industrial context, the method can be used to develop and deploy specialized autonomous algorithms for chemical manufacturing, automated material discovery, energy storage testing, and decryption. This enables companies to build powerful quantum simulation tools that extract complete, mathematically consistent physical measurements from noisy hardware, thereby streamlining research and development operations and overcoming the fundamental hardware limitations of near term quantum devices.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for mitigating error in a quantum computing device, the method comprising:
receiving quantum circuit specification data defining a quantum circuit configuration, the quantum circuit configuration specifying a plurality of quantum gates;
obtaining a set of implementable quantum gates, each of the implementable quantum gates corresponding to a quantum operation capable of being executed by hardware of the quantum computing device;
determining a noise representation associated with a physical implementation of a target gate among the plurality of quantum gates;
determining an inverse noise representation based on the noise representation;
generating a generalized quasi-probabilistic decomposition of the inverse noise representation based on the set of implementable quantum gates, the generalized quasi-probabilistic decomposition including a positive component and a negative component;
generating an updated quantum circuit configuration by inserting at least one implementable quantum gate subsequent to the target gate, wherein the at least one implementable quantum gate is selected from among the set of implementable quantum gates to correspond to the positive component of the generalized quasi-probabilistic decomposition, and wherein the negative component of the generalized quasi-probabilistic decomposition is excluded;
transmitting the updated quantum circuit configuration to the quantum computing device for execution; and
receiving an expectation value from the quantum computing device based on the execution of the updated quantum circuit configuration.

2. The method of claim 1, wherein the determining the noise representation includes:
generating a measured transfer matrix of the target gate; and
extracting a noise matrix as the noise representation by multiplying the measured transfer matrix by an inverse of an ideal transfer matrix corresponding to the target gate.

3. The method of claim 2, wherein the generating the measured transfer matrix includes causing an execution of an on-hardware gate set tomography (GST) protocol on the quantum computing device.

4. The method of claim 1, further comprising:
receiving a plurality of measurement outcomes from the quantum computing device based on a plurality of iterations of the updated quantum circuit configuration being run on the quantum computing device; and
computing the expectation value as an average of the plurality of measurement outcomes without tracking a parity sign to reduce a statistical sampling overhead.

5. The method of claim 1, wherein the target gate is a multi-qubit gate, and
wherein the method further comprises selectively skipping an error mitigation process for at least one single-qubit gate among the plurality of quantum gates to reduce a computational overhead.

6. The method of claim 1, wherein the generating the generalized quasi-probabilistic decomposition includes:
discarding all negative coefficients from a linear combination of physically implementable basis gates associated with the inverse noise representation; and
re-normalizing remaining positive weights to create a strictly-positive probability distribution for a location of the target gate.

7. The method of claim 6, wherein the generating the updated quantum circuit configuration includes stochastically sampling the at least one implementable quantum gate from the strictly-positive probability distribution using a Monte Carlo sampling technique.

8. The method of claim 1, wherein the at least one implementable quantum gate inserted subsequent to the target gate includes a Pauli gate.

9. The method of claim 1, wherein the generating the updated quantum circuit configuration includes generating a plurality of unique circuit configurations for a plurality of hardware shots, and
wherein a randomized selection process dynamically inserts a varying sampled implementable quantum gate subsequent to the target gate for individual hardware shots among the plurality of hardware shots.

10. The method of claim 1, further including:
inputting the expectation value into a classical optimizer as a cost function or a gradient metric; and
iteratively updating a parameter of the quantum circuit configuration based on the expectation value to minimize the cost function and output an optimized solution for a downstream computational task.

11. The method of claim 10, wherein the classical optimizer executes a hybrid quantum-classical algorithm including at least one of a variational quantum eigensolver (VQE) algorithm, a quantum approximate optimization algorithm (QAOA), or a quantum machine learning (QML) training loop.

12. An artificial intelligence (AI) device, comprising:
a memory configured to store measured expectation values; and
a controller configured to:
receive quantum circuit specification data defining a quantum circuit configuration, the quantum circuit configuration specifying a plurality of quantum gates,
obtain a set of implementable quantum gates, each of the implementable quantum gates corresponding to a quantum operation capable of being executed by hardware of a quantum computing device,
determine a noise representation associated with a physical implementation of a target gate among the plurality of quantum gates,
determine an inverse noise representation based on the noise representation,
generate a generalized quasi-probabilistic decomposition of the inverse noise representation based on the set of implementable quantum gates, the generalized quasi-probabilistic decomposition including a positive component and a negative component,
generate an updated quantum circuit configuration by inserting at least one implementable quantum gate subsequent to the target gate, wherein the at least one implementable quantum gate is selected from among the set of implementable quantum gates to correspond to the positive component of the generalized quasi-probabilistic decomposition, and wherein the negative component of the generalized quasi-probabilistic decomposition is excluded,
transmit the updated quantum circuit configuration to the quantum computing device for execution, and
receive an expectation value from the quantum computing device based on the execution of the updated quantum circuit configuration.

13. The AI device of claim 12, wherein, to determine the noise representation, the controller is further configured to:
generate a measured transfer matrix of the target gate, and
extract a noise matrix as the noise representation by multiplying the measured transfer matrix by an inverse of an ideal transfer matrix corresponding to the target gate.

14. The AI device of claim 13, wherein, to generate the measured transfer matrix, the controller is further configured to cause an execution of an on-hardware gate set tomography (GST) protocol on the quantum computing device.

15. The AI device of claim 12, wherein the controller is further configured to:
receive a plurality of measurement outcomes from the quantum computing device based on a plurality of iterations of the updated quantum circuit configuration being run on the quantum computing device, and
compute the expectation value as an average of the plurality of measurement outcomes without tracking a parity sign to reduce a statistical sampling overhead.

16. The AI device of claim 12, wherein, to generate the generalized quasi-probabilistic decomposition, the controller is further configured to:
discard all negative coefficients from a linear combination of physically implementable basis gates associated with the inverse noise representation, and
re-normalize remaining positive weights to create a strictly-positive probability distribution for a location of the target gate.

17. The AI device of claim 16, wherein, to generate the updated quantum circuit configuration, the controller is further configured to stochastically sample the at least one implementable quantum gate from the strictly-positive probability distribution using a Monte Carlo sampling technique.

18. The AI device of claim 12, wherein, to generate the updated quantum circuit configuration, the controller is further configured to generate a plurality of unique circuit configurations for a plurality of hardware shots, and
wherein a randomized selection process dynamically inserts a varying sampled implementable quantum gate subsequent to the target gate for individual hardware shots among the plurality of hardware shots.

19. The AI device of claim 12, wherein the controller is further configured to:
input the expectation value into a classical optimizer as a cost function or a gradient metric, wherein the classical optimizer executes a hybrid quantum-classical algorithm including at least one of a variational quantum eigensolver (VQE) algorithm, a quantum approximate optimization algorithm (QAOA), or a quantum machine learning (QML) training loop, and
iteratively update a parameter of the quantum circuit configuration based on the expectation value to minimize the cost function and output an optimized solution for a downstream computational task.

20. A non-transitory computer-readable storage medium storing instructions that, when executed by one or more processors, cause the one or more processors to perform operations comprising:
receiving quantum circuit specification data defining a quantum circuit configuration, the quantum circuit configuration specifying a plurality of quantum gates;
obtaining a set of implementable quantum gates, each of the implementable quantum gates corresponding to a quantum operation capable of being executed by hardware of a quantum computing device;
determining a noise representation associated with a physical implementation of a target gate among the plurality of quantum gates;
determining an inverse noise representation based on the noise representation;
generating a generalized quasi-probabilistic decomposition of the inverse noise representation based on the set of implementable quantum gates, the generalized quasi-probabilistic decomposition including a positive component and a negative component;
generating an updated quantum circuit configuration by inserting at least one implementable quantum gate subsequent to the target gate, wherein the at least one implementable quantum gate is selected from among the set of implementable quantum gates to correspond to the positive component of the generalized quasi-probabilistic decomposition, and wherein the negative component of the generalized quasi-probabilistic decomposition is excluded;
transmitting the updated quantum circuit configuration to the quantum computing device for execution; and
receiving an expectation value from the quantum computing device based on the execution of the updated quantum circuit configuration.
